(19) United States
(12) Patent Application Publication
(10) Pub. No.: US 2018/0198139 A1
(43) Pub. Date: Jul. 12, 2018

(54) FUEL CELL, CONTROL METHOD AND COMPUTER READABLE RECORDING MEDIUM

(71) Applicant: BROTHER KOGYO KABUSHIKI KAISHA, Nagoya-shi (JP)

(72) Inventor: Atsuki IKOMA, Nagoya-shi (JP)

(21) Appl. No.: 15/914,454

(22) Filed: Mar. 7, 2018

Related U.S. Application Data
(63) Continuation of application No. PCT/JP2016/071813, filed on Jul. 26, 2016.

(30) Foreign Application Priority Data
Sep. 17, 2015 (JP) 2015-184505

(51) Int. Cl. H01M 8/04029; H01M 8/04007; H01M 8/04701

(52) U.S. Cl. CPC H01M 8/04029; H01M 8/10; H01M 8/04701; H01M 8/04074

(57) ABSTRACT

To provide: a fuel cell, with which the level of contamination of a cooling passage becomes lower, lowering of the power generation efficiency of the power generation unit due to rise in the conductivity of the heat medium is suppressed, it is possible to control the heat radiation amount, and it is possible to use a common fan as a fan for ventilation and a fan for a radiator; a control method of controlling heat exchange in a fuel cell; and a computer readable recording medium storing a computer program for causing a computer to execute control processing of heat exchange.

The fuel cell is provided with: a stack cooling passage configured to cool a stack, which generates electricity by reacting hydrogen and oxygen, by circulation of a first heat medium; a radiator flow passage, which allows a second heat medium to flow through a radiator and circulate; a cooling pump provided at the stack cooling passage; a heat radiation pump provided at the radiator flow passage; and a heat exchanger configured to perform heat exchange between the first heat medium and the second heat medium.

### CROSS-REFERENCE TO RELATED APPLICATIONS

The present application is a continuation application of International Application No. PCT/JP2016/71813, filed Jul. 26, 2016, which claims priority to Japanese Patent Application No. 2015-184505, filed Sep. 17, 2015. The contents of these applications are incorporated herein by reference in their entirety.

### FIELD

The present invention relates to: a fuel cell, which is provided with a power generation unit configured to generate electricity by reacting hydrogen and oxygen, and a cooling passage configured to cool the power generation unit by circulation of cooling water; a control method of controlling heat exchange in a fuel cell; and a computer readable recording medium storing a computer program for causing a computer to execute control processing of heat exchange.

Examples of a cell wherein hydrogen is sent to a negative electrode so that electromotive force is obtained include a fuel cell, a nickel-hydrogen cell and the like.

Since a fuel cell is a clean power generator having high power generation efficiency and it is possible with a fuel cell to construct a cogeneration system without being affected by the magnitude of the load, it is considered to use a fuel cell for various purposes including a personal computer, a digital household electric appliance such as a portable telephone, an electric car, a railroad, a base station of a portable telephone, a power plant and the like.

A fuel cell is provided with a stack, which is obtained by sandwiching a solid polymer electrolyte membrane with a negative electrode and a positive electrode from both sides so as to form a membrane electrode assembly, locating a pair of separators on both sides of the membrane electrode assembly so as to compose a platelike unit cell, and laminating and packaging a plurality of such unit cells. When hydrogen is supplied to the stack so that fuel gas including hydrogen comes into contact with the negative electrode of the stack and oxidation gas including oxygen such as air comes into contact with the positive electrode, an electrochemical reaction occurs on both electrodes and electromotive force is generated.

Since heat is generated at the stack during power generation, a fuel cell is generally provided with a cooling passage configured to cool the stack.

For example, cooling water in a cooling passage is guided into a cooling water communication passage of the stack by a water pump and flows through the cooling water communication passage while cooling the stack, and the heated cooling water is discharged from the stack as disclosed in Japanese Patent Application Laid-Open No. 2003-168461. This cooling water having heat is subjected to heat exchange with a radiator and a radiator fan, and the cooled cooling water is returned to the stack by the water pump and is then circulated.

A fuel cell of Japanese Patent Application Laid-Open No. 2003-168461 is constructed to lower the temperature in a housing of the fuel cell by increasing the fan speed of the radiator fan so as to guide outside air into the housing for the purpose of ventilation and cooling when the temperature in the housing is equal to or higher than a predetermined value. The fuel cell is also constructed in a manner such that a three-way selector valve is switched over so that cooling water bypasses a passage to the radiator when the temperature of the cooling water is lower than a predetermined value.

### SUMMARY

In the case of a fuel cell of Japanese Patent Application Laid-Open No. 2003-168461 wherein a cooling passage is constituted of only one path, it is necessary to use the same refrigerant and therefore it is impossible to use different refrigerants between the stack (heat generation unit) side and the radiator (heat radiation unit) side. Accordingly, in a case where the stack corresponds only to pure water, there is a problem that only pure water can be used and therefore only SUS or the like wherein the elution amount of metal ions is small can be used as the material of the parts of the path in the radiator or the like. When a metal ion is generated in the cooling passage while power generation is continued, there arises a problem that the metal ion causes rise in the conductivity of cooling water, lowering of the power generation efficiency of the stack, and shortening of the life. An impurity such as a metal ion is generated mainly in the radiator. In order to remove such a metal ion or the like, it is necessary to compose the parts of the cooling passage with SUS or the like, or to regularly perform maintenance such as replacement of refrigerant or ion exchange resin.

The present invention has been made in view of such circumstances, and the object thereof is to provide: a fuel cell by which the level of contamination of the cooling passage becomes lower, and lowering of the power generation efficiency of the power generation unit due to rise in the conductivity of the heat medium is suppressed; a control method of controlling heat exchange in the fuel cell; and a computer readable recording medium storing a computer program for causing a computer to execute control processing of heat exchange.

A fuel cell according to an aspect of the present disclosure comprises: a power generation unit cooling passage configured to cool a power generation unit, which generates electricity by reacting hydrogen and oxygen, by circulation of a first heat medium; a radiator flow passage, which allows a second heat medium to flow through a radiator and circulate; a first circulation pump provided at the power generation unit cooling passage; a second circulation pump provided at the radiator flow passage; a heat exchanger configured to perform heat exchange between the first heat medium and the second heat medium; a first temperature detector configured to detect temperature of the first heat medium on an inlet side of the power generation unit; and a second temperature detector configured to detect temperature of the first heat medium on an outlet side of the power generation unit, wherein the fuel cell is constructed in a manner such that output of the first circulation pump or the second circulation pump is controlled on the basis of temperature detected by the first temperature detector or the second temperature detector and output of the second circulation pump is decreased if the temperature of the first heat medium detected by the second temperature detector is equal to or lower than a predetermined value.

A control method according to an aspect of the present disclosure of controlling heat exchange in a fuel cell, which is provided with a power generation unit cooling passage that allows a first circulation pump to circulate a first heat medium so as to cool a power generation unit configured to generate electricity by reacting hydrogen and oxygen, a radiator flow passage that allows a second circulation pump to circulate a second heat medium configured to conduct heat generated by the power generation unit to a radiator, and a heat exchanger configured to perform heat exchange between the first heat medium and the second heat medium, comprises: acquiring temperature of the first heat medium on an inlet side of the power generation unit or temperature of the first heat medium on an outlet side of the power generation unit; and controlling output of the first circulation pump or the second circulation pump on the basis of temperature of the first heat medium on the inlet side or the outlet side; and decreasing output of the second circulation pump if the temperature of the first heat medium detected by the second temperature detector is equal to or lower than a predetermined value, in controlling the output of the second circulation pump.

In a non-transitory computer readable recording medium according to an aspect of the present disclosure, storing a computer program for causing a computer to control heat exchange in the fuel cell provided with a power generation unit cooling passage that allows a first circulation pump to circulate a first heat medium so as to cool a power generation unit configured to generate electricity by reacting hydrogen and oxygen, a radiator flow passage that allows a second circulation pump to circulate a second heat medium configured to conduct heat generated by the power generation unit to a radiator, and a heat exchanger configured to perform heat exchange between the first heat medium and the second heat medium, the computer program causes the computer to execute processing of: acquiring temperature of the first heat medium on an inlet side of the power generation unit or temperature of the first heat medium on an outlet side of the power generation unit; controlling output of the first circulation pump or the second circulation pump on the basis of temperature of the first heat medium on the inlet side or the outlet side; and decreasing output of the second circulation pump if the temperature of the first heat medium on the outlet side is equal to or lower than a predetermined value, in controlling the output of the second circulation pump.

With the present disclosure provided with a power generation unit cooling passage through which a first heat medium circulates, a radiator flow passage through which a second heat medium circulates, and a heat exchanger configured to perform heat exchange between the first heat medium and the second heat medium, a cooling passage is divided between the power generation unit side and the radiator side, and each of the power generation unit cooling passage and the radiator flow passage has a simple structure and a small length. Accordingly, the area of a pollution source such as piping becomes smaller, the level of contamination of the first heat medium and the second heat medium becomes lower, lowering of the power generation efficiency of the power generation unit due to rise in the conductivity of the heat medium caused by metal ions or the like is suppressed, and shortening of the life of the power generation unit is suppressed.

The above and further objects and features will more fully be apparent from the following detailed description with accompanying drawings.

### BRIEF DESCRIPTION OF THE DRAWINGS

FIG. 1 is a block diagram illustrating a fuel cell according to Embodiment 1;

FIG. 2 is a flowchart illustrating control processing of a stack cooling passage by a CPU;

FIG. 3 is a flowchart illustrating control processing of a radiator flow passage by a CPU;

FIG. 4 is a block diagram illustrating a fuel cell according to Embodiment 2.

### DETAILED DESCRIPTION

The following description will explain the present invention in detail with reference to the drawings illustrating some embodiments thereof.

### Embodiment 1

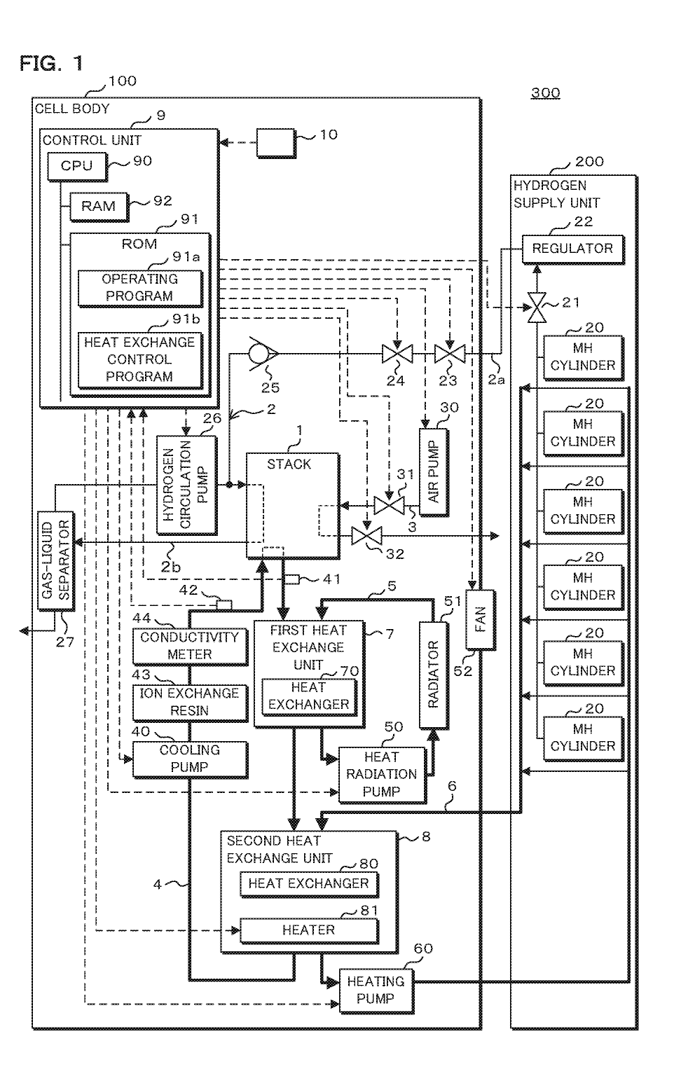

FIG. 1 is a block diagram illustrating a fuel cell 300 according to Embodiment 1.

The fuel cell 300 is a fuel cell such as a polymer electrolyte fuel cell, for example.

The fuel cell 300 is provided with a cell body 100 and a hydrogen supply unit 200.

The cell body 100 is provided with a stack 1, a hydrogen flow passage 2 (a hydrogen supply passage 2a and a hydrogen circulation passage 2b), an air flow passage 3, a stack cooling passage 4, a radiator flow passage 5, a cylinder heating passage 6, a first heat exchange unit 7, a second heat exchange unit 8, a control unit 9, a hydrogen detection sensor 10, a gas-liquid separator 27, a hydrogen circulation pump 26, an air pump 30, a cooling pump 40, a heat radiation pump 50, a radiator 51, a fan 52 and a heating pump 60.

The hydrogen supply unit 200 is provided with a plurality of MH (Metal Hydride) cylinders 20, an on-off valve 21 and a regulator 22. Each MH cylinder 20 is filled with hydrogen storage alloy. The on-off valve 21 is connected with all MH cylinders 20 and is also connected with the regulator 22. The supply pressure of hydrogen is adjusted by the regulator 22. A reaction that the hydrogen storage alloy in the MH cylinders 20 releases hydrogen is an endothermic reaction.

The stack 1 is obtained by sandwiching a solid polymer electrolyte membrane with a negative electrode and a positive electrode from both sides so as to form a membrane electrode assembly, locating a pair of separators on both sides of the membrane electrode assembly so as to compose a platelike unit cell, and laminating and packaging a plurality of such unit cells.

When fuel gas including hydrogen, which has flown in from the hydrogen supply unit 200, comes into contact with the negative electrode and oxidation gas including oxygen such as air flows in from the air flow passage 3 and comes into contact with the positive electrode, an electrochemical reaction occurs on both electrodes and electromotive force is generated. In this electrochemical reaction, water is generated from a reaction between a hydrogen ion, which has been transmitted through the solid polymer electrolyte membrane from the negative electrode side, and oxygen in oxidation gas.

One end part of the hydrogen supply passage 2a is connected with the regulator 22, and the other end part is connected with a part, which is close to the negative electrode of the stack 1, of the hydrogen circulation passage 2b. The hydrogen supply passage 2a is provided with an on-off valve 23, an on-off valve 24 and a check valve 25, which are positioned in this order from the hydrogen supply unit 200 side.

The hydrogen circulation pump 26 is provided at the hydrogen circulation passage 2b. The fuel cell 300 is constructed in a manner such that, when the on-off valve 23 and the on-off valve 24 are opened, hydrogen flows from the regulator 22 through the on-off valve 23, the on-off valve 24, the check valve 25 and the hydrogen supply passage 2a, is caused by the hydrogen circulation pump 26 to flow through the hydrogen circulation passage 2b, is sent out to a negative electrode side part of the stack 1, and is caused to flow through a flow passage in this part. Hydrogen, which has flown through the flow passage and is discharged from the stack 1, flows through the hydrogen circulation passage 2b and is sent to the gas-liquid separator 27. In the gas-liquid separator 27, the hydrogen is separated into gas, which includes hydrogen and impurities, and water, and hydrogen obtained by the separation is sent from the gas-liquid separator 27 to the hydrogen circulation pump 26 and is then circulated. Water obtained by the separation at the gas-liquid separator 27 is discharged to outside by opening a drain valve (unillustrated), and gas including impurities is discharged to outside by opening an exhaust valve (unillustrated) at a proper timing.

The air pump 30 is provided at the air flow passage 3. In addition, an on-off valve 31 is provided at an inlet side part of the air flow passage 3 to the stack 1, and an on-off valve 32 is provided at an outlet side part from the stack 1. The fuel cell 300 is constructed in a manner such that, when the on-off valve 31 and the on-off valve 32 are opened, air sent out from the air pump 30 flows through the air flow passage 3 and the on-off valve 31, is guided into a positive electrode side part of the stack 1, and flows through a flow passage of this part. Air, which has flown through the flow passage, is discharged from the stack 1, and is discharged through the on-off valve 32 to outside.

A cooling pump 40, an ion exchange resin 43 and a conductivity meter 44 are provided at the stack cooling passage 4. The fuel cell 300 is constructed in a manner such that cooling water, which is sent out from the cooling pump 40 and flows through the stack cooling passage 4, flows through the ion exchange resin 43, the conductivity of the cooling water is measured by the conductivity meter 44, and the cooling water is then guided into the stack 1, flows through a flow passage in the stack 1, is then discharged, flows through the first heat exchange unit 7 and the second heat exchange unit 8, and returns to the cooling pump 40. Temperature sensors 41 and 42 are provided respectively at an outlet side of cooling water of the stack cooling passage 4 from the stack 1 and at an inlet side to the stack 1. The temperature sensors 41 and 42 respectively detect temperatures T₁° C. and T₂° C. The ion exchange resin 43 adsorbs ions included in cooling water, which flows through the stack cooling passage 4. When the ion content becomes high, the conductivity of cooling water becomes high and the power generation efficiency of the stack 1 lowers, and it is therefore necessary to cause the ion exchange resin 43 to adsorb metal ions or the like.

In a case where a stack 1 which can use only pure water as refrigerant is employed, pure water (cooling water) is used as a heat medium (a first heat medium) of the stack cooling passage 4. In a case where antifreeze liquid composed mainly of ethylene glycol, for example, can be used as refrigerant of the stack 1, the first heat medium is the antifreeze liquid.

The first heat exchange unit 7 is provided with a heat exchanger 70, and the second heat exchange unit 8 is provided with a heat exchanger 80 and a heater 81.

The heat radiation pump 50 is provided at the radiator flow passage 5. The fuel cell 300 is constructed in a manner such that heat radiation liquid sent out from the heat radiation pump 50 flows through the radiator 51, further flows through the heat exchanger 70 of the first heat exchange unit 7, and then returns to the heat radiation pump 50. Here, an example of heat radiation liquid (a second heat medium) is antifreeze liquid composed mainly of ethylene glycol, for example Water may also be used as the heat radiation liquid. Since antifreeze liquid includes various chemical agents such as a rust-preventive agent, the parts such as the radiator 51 of the radiator flow passage 5 hardly rust. Moreover, a hole is hardly formed in a case where a radiator 51 made of aluminum is employed. In addition, freezing does not occur in the radiator flow passage 5 even when the outside air temperature is below the freezing point.

The fan 52 is provided in proximity to the radiator 51.

The heating pump 60 is provided at the cylinder heating passage 6. The fuel cell 300 is constructed in a manner such that heating liquid sent out from the heating pump 60 flows through a flow passage in the hydrogen supply unit 200 while heating each MH cylinder 20, is then discharged from the hydrogen supply unit 200, flows through the second heat exchange unit 8, and returns to the heating pump 60. Hydrogen is released from the hydrogen storage alloy in each MH cylinder 20 by heating. An example of heating liquid is the antifreeze liquid.

The stack cooling passage 4, the radiator flow passage 5, the cylinder heating passage 6, the first heat exchange unit 7 and the second heat exchange unit 8 are covered with heat insulating material.

Accordingly, it is possible to restrict heat transfer with outside, and it is easy to control the heat quantity.

The control unit 9 is provided with a CPU (Central Processing Unit) 90 configured to control operations of the respective components of the control unit 9, and the CPU 90 is connected with a ROM 91 and a RAM 92 via a bus.

The ROM 91 is a nonvolatile memory such as an EEPROM (Electrically Erasable Programmable ROM), and stores an operating program 91a of the fuel cell 300, and a heat exchange control program 91b according to this embodiment.

Moreover, the heat exchange program 91b may be recorded on a recording medium such as a CD (Compact Disc)-ROM, which is a portable medium for computer-readable recording, a DVD (Digital Versatile Disc)-ROM, a BD (Blu-ray (registered trademark) Disc), a hard disc drive or a solid-state drive, so that the CPU 90 reads out the heat exchange program 91b from the recording medium and stores the heat exchange program 91b in the ROM 91.

Furthermore, the heat exchange program 91b according to the present invention may also be acquired from an unillustrated external computer, which is connected with a communication network, and be stored in the ROM 91.

The RAM 92 is a memory such as a DRAM (Dynamic RAM) or an SRAM (Static RAM), and temporarily stores the operating program 91a, which is read out from the ROM 91 in the process of execution of arithmetic processing by the CPU 90, the heat exchange program 91b, and various data, which are generated in arithmetic processing by the CPU 90. The control unit 9 is connected with the respective components of the cell body 100, and the on-off valve 21 of the hydrogen supply unit 200, and the control unit 9 controls operations of the respective components and the on-off valve 21.

The hydrogen detection sensor 10 outputs a detection signal to the control unit 9 when the hydrogen detection sensor 10 detects hydrogen leakage.

A reaction, which occurs at the stack 1, is an exothermic reaction, and the stack 1 is cooled by cooling water, which flows through the stack cooling passage 4. Heat of cooling water, which has been discharged from the stack 1, is conducted to heat radiation liquid at the heat exchanger 70, the heat radiation liquid radiates heat at the radiator 51, and heat is radiated to outside of the cell body 100 by the fan 52. Heat radiation liquid, which has been cooled at the radiator 51, is sent to the first heat exchange unit 7.

Heat of cooling water, which has flown through the first heat exchange unit 7 and has been guided into the second heat exchange unit 8 in the stack cooling passage 4, is conducted to heating liquid at the second heat exchange unit 8, and the heating liquid heats each MH cylinder 20 of the hydrogen supply unit 200, and releases hydrogen from the hydrogen storage alloy.

Cooling water, which has been cooled at the second heat exchange unit 8, returns to the cooling pump 40, and is sent to the stack 1.

Although the temperature of cooling water in the stack cooing passage 4 becomes the environmental temperature when power generation is not performed, it is possible to maintain each MH cylinder 20 at a predetermined temperature by heating the heating liquid with the heater 81 of the second heat exchange unit 8.

It is to be noted that it is also possible to send air, which has heat generated at the stack 1, to the hydrogen supply unit 200 so as to heat each MH cylinder 20, without providing the cylinder heating passage 6.

In this embodiment, the fuel cell 300 according to Embodiment 1 having the above structure is used to acquire a temperature T₁ of cooling water detected by the temperature sensor 41 on the outlet side of the stack 1, or a temperature T₂ of cooling water detected by the temperature sensor 42 on the inlet side of the stack 1, control output of the cooling pump 40 or the heat radiation pump 50 on the basis of such a temperature so as to control heat exchange, and control cooling of the stack 1 and heat radiation to outside.

The CPU 90 of the control unit 9 reads out the heat exchange control program from the ROM 91, and executes control processing of heat exchange. The following description will explain control processing of heat exchange.

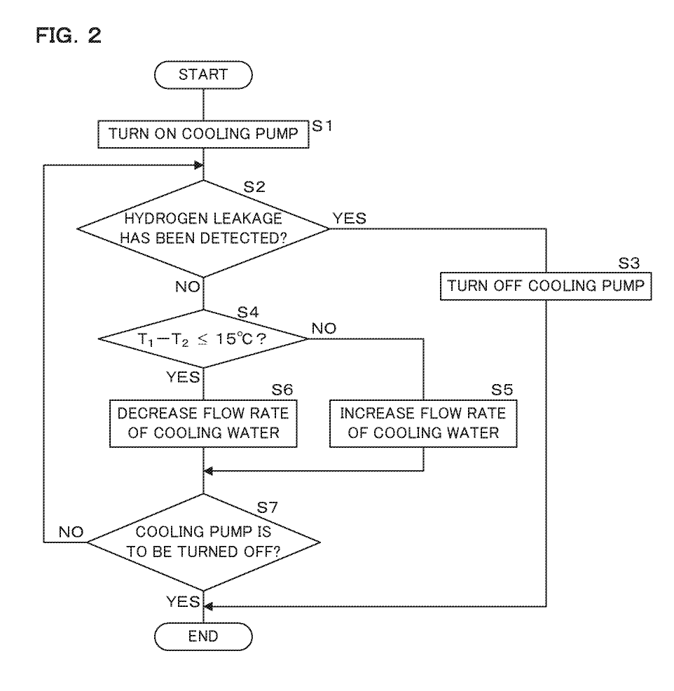

FIG. 2 is a flowchart illustrating control processing of the stack cooling passage 4 by the CPU 90.

First, the CPU 90 turns on the cooling pump 40 (S1).

The CPU 90 determines whether hydrogen leakage has been detected by the hydrogen detection sensor 10 or not (S2).

When determining that hydrogen leakage has been detected (S2: YES), the CPU 90 turns off the cooling pump 40 (S3), stops supply of hydrogen from the hydrogen supply unit 200, and terminates control processing of the stack cooling passage 4.

When determining that hydrogen leakage has not been detected (S2: NO), the CPU 90 determines whether a difference (T₁−T₂) between temperatures T₁° C. and T₂° C. acquired from the temperature sensors 41 and 42 is equal to or lower than 15° C. or not (S4).

When determining that the difference is higher than 15° C. (S4: NO), the CPU 90 raises an indication voltage to the cooling pump 40, increases the flow rate of cooling water to be sent out from the cooling pump 40 (S5), and advances the processing to step S7. Increase in the flow rate of cooling water achieves temperature lowering of the stack 1.

When determining that the difference is equal to or lower than 15° C. (S4: YES), the CPU 90 lowers an indication voltage to the cooling pump 40, and decreases the flow rate of cooling water to be sent out from the cooling pump 40 (S6). This can prevent overcooling of the cooling water.

The CPU 90 determines whether the cooling pump 40 is to be turned off or not (S7). An example of a case where it is determined that the cooling pump 40 is to be turned off is a case where an instruction from a worker to stop power generation is accepted or the like.

When determining that the cooling pump 40 is to be turned off (S7: YES), the CPU 90 terminates control processing of the cooling passage 4.

When determining that the cooling pump 40 is not to be turned off (S7: NO), the CPU 90 returns the processing to step S2.

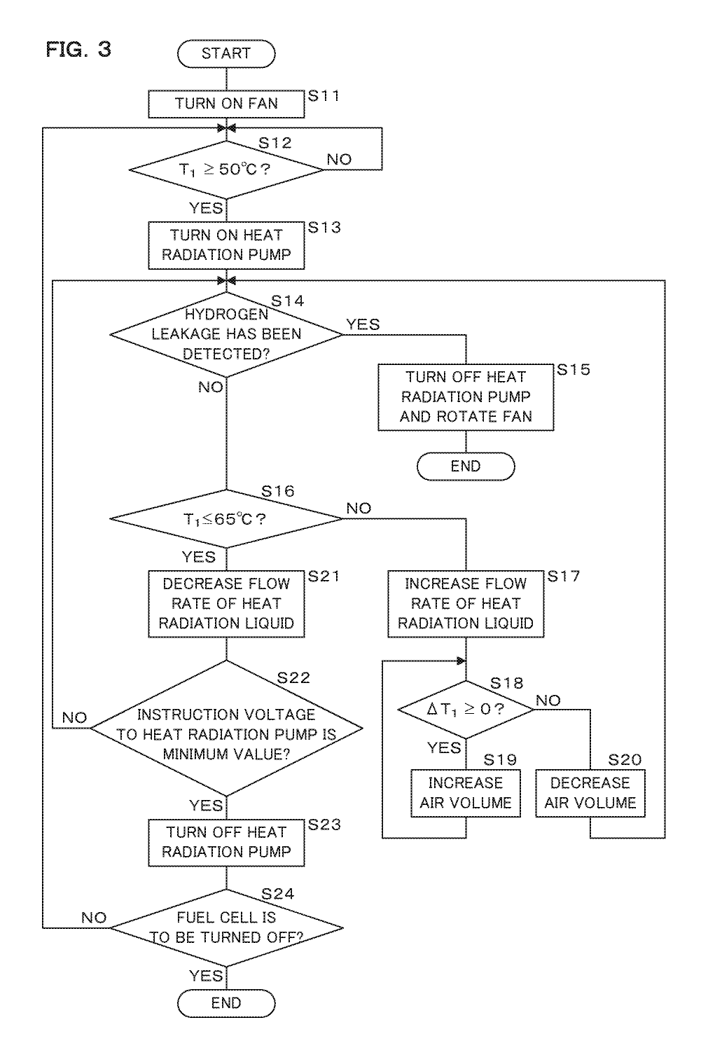

FIG. 3 is a flowchart illustrating control processing of the radiator flow passage 5 by the CPU 90.

First, the CPU 90 turns on the fan 52 (S11). Here, the fan speed of the fan 52 is a minimum fan speed required for ventilation.

The CPU 90 determines whether the temperature T₁° C. acquired from the temperature sensor 41 satisfies T₁≥50° C. or not (S12).

When determining that T₁≥50° C. is not satisfied (S12: NO), the CPU 90 repeats the determination processing.

When determining that T₁≥50° C. is satisfied (S12: YES), the CPU 90 turns on the heat radiation pump 50 (S13).

The CPU 90 determines whether hydrogen leakage has been detected by the hydrogen detection sensor 10 or not (S14).

When determining that hydrogen leakage has been detected (S14: YES), the CPU 90 turns off the heat radiation pump 50 (S15), stops supply of hydrogen from the hydrogen supply unit 200, and terminates control processing of the radiator flow passage 5. At this time, rotation of the fan 52 is continued.

When determining that hydrogen leakage has not been detected (S14: NO), the CPU 90 determines whether the temperature T₁° C. acquired from the temperature sensor 41 satisfies T₁≤65° C. or not (S16).

When determining that T₁≤65° C. is not satisfied (S16: NO), the CPU 90 raises an instruction voltage to the heat radiation pump 50, and increases the flow rate of heat radiation liquid to be sent out from the heat radiation pump 50 (S17). This increases the heat radiation amount, further cools the cooling water, and achieves further cooling of the stack 1.

The CPU 90 determines whether a variation ΔT₁ of the temperature T₁ acquired from the temperature sensor 41 for ten seconds satisfies ΔT₁≥0 or not (S18). It is to be noted that the variation ΔT₁ of T₁ may be obtained every twenty seconds.

When determining that ΔT₁≥0 is not satisfied (S18: NO), the CPU 90 decreases the fan speed of the fan 52 so as to decrease the air volume (S20), and returns the processing to step S14. Since T₁ is lower, the heat radiation amount is lowered by decreasing the air volume of the fan 52.

When determining that ΔT₁≥0 is satisfied (S18: YES), the CPU 90 increases the fan speed of the fan 52 so as to increase the air volume (S19), and returns the processing to step S18. Since T₁ is higher, the heat radiation amount is raised by increasing the air volume of the fan 52.

When determining in step S16 that T₁≤65° C. is satisfied (S16: YES), the CPU 90 lowers an instruction voltage to the heat radiation pump 50, and decreases the flow rate of heat radiation liquid to be sent out from the heat radiation pump 50 (S21).

The CPU 90 determines whether an instruction voltage to the heat radiation pump 50 is the minimum value or not (S22).

When determining that the instruction voltage to the heat radiation pump 50 is not the minimum value (S22: NO), the CPU 90 returns the processing to step S14.

When determining that the instruction voltage to the heat radiation pump 50 is the minimum value (S22: YES), the CPU 90 turns off the heat radiation pump 50 (S23). Since the instruction voltage converges to the minimum value by repeating lowering of the heat radiation amount, driving of the heat radiation pump 50 is stopped.

The CPU 90 determines whether the entire system of the fuel cell 300 is to be turned off or not (S24). An example of a case where the entire system is to be turned off is a case where an instruction from a worker to stop power generation is accepted or the like.

When determining that the entire system of the fuel cell 300 is not to be turned off (S24: NO), the CPU 90 returns the processing of the radiator flow passage 5 to step S12.

When determining that the entire system of the fuel cell 300 is to be turned off (S24: YES), the CPU 90 terminates the processing.

It is to be noted that the thresholds of the temperature are not limited to the above values in the flowcharts of FIGS. 2 and 3.

In this embodiment, the cooling passage is divided between the stack 1 side and the radiator 51 side, and each of the stack cooling passage 4 and the radiator flow passage 5 has a simple structure and a small length. Accordingly, the area of a pollution source such as piping becomes smaller, the level of contamination of the first heat medium and the second heat medium becomes lower, lowering of the power generation efficiency of the stack 1 due to rise in the conductivity caused by metal ions or the like is suppressed, and shortening of the life of the stack 1 is suppressed.

In addition, since the cooling passage is divided into two paths, it is possible to use pure water in a case where antifreeze liquid cannot be used as the first heat medium on the stack 1 side, and use antifreeze liquid as the second heat medium on the radiator 51 side. Since antifreeze liquid includes various chemical agents such as a rust-preventive agent, the parts of the radiator flow passage 5 hardly rust, and generation of metal ions is suppressed. Accordingly, it is unnecessary to use SUS or the like wherein the elution amount of metal ions is small as the material of the path parts such as the radiator 51 of the radiator flow passage 5 and aluminum can be used, and therefore cost down is achieved.

In a conventional fuel cell such as Japanese Patent Application Laid-Open No. 2003-168461 wherein cooling water circulates between a stack and a radiator, it is necessary to control both of the flow rate of cooling water required for cooling and the air volume of a fan configured to cool a radiator at the same time. In addition, it is also necessary to secure an air volume of the fan equal to or larger than a predetermined value for ventilation of a housing, and therefore it is difficult to use a common fan as a fan for housing ventilation and a radiator fan having a small air volume.

In this embodiment, it is possible to control the heat radiation amount by only controlling the flow rate of the radiator flow passage 5 (the heat radiation unit side) without depending on the flow rate of the stack cooling passage 4 (the heat generation unit side). Accordingly, it is possible to control the flow rate of the radiator flow passage 5 so as to control the heat radiation amount while securing a minimum required ventilation volume of a housing of the cell body 100 of the fuel cell 300. It is therefore possible to provide the fan 52 with both functions of radiation of heat from the radiator 51 and ventilation of the housing of the cell body 100. In addition, it is also possible to stop the entire system of the fuel cell 300 and to dilute and discharge hydrogen when hydrogen leaks.

In this embodiment, it is possible to control the heat quantity, which is transferred in the first heat exchange unit 7, by controlling outputs of the cooling pump 40 and the heat radiation pump 50, that is, the circulation volume. Since the heat quantity taken at the first heat exchange unit 7 increases as the circulation volume of the radiator flow passage 5 becomes larger, it is possible to finely control the heat quantity by suitably combining outputs of the two pumps.

In addition, since it is possible to manage the temperature difference of cooling water between the input side and the output side of the stack 1, it is possible to stabilize the temperature of the stack 1 even under low-temperature environment by decreasing the heat radiation amount or the like.

In addition, in this embodiment, the heat quantity taken at the first heat exchange unit 7 is restricted and overcooling of the cooling water is prevented by decreasing the output of the heat radiation pump 50.

### Embodiment 2

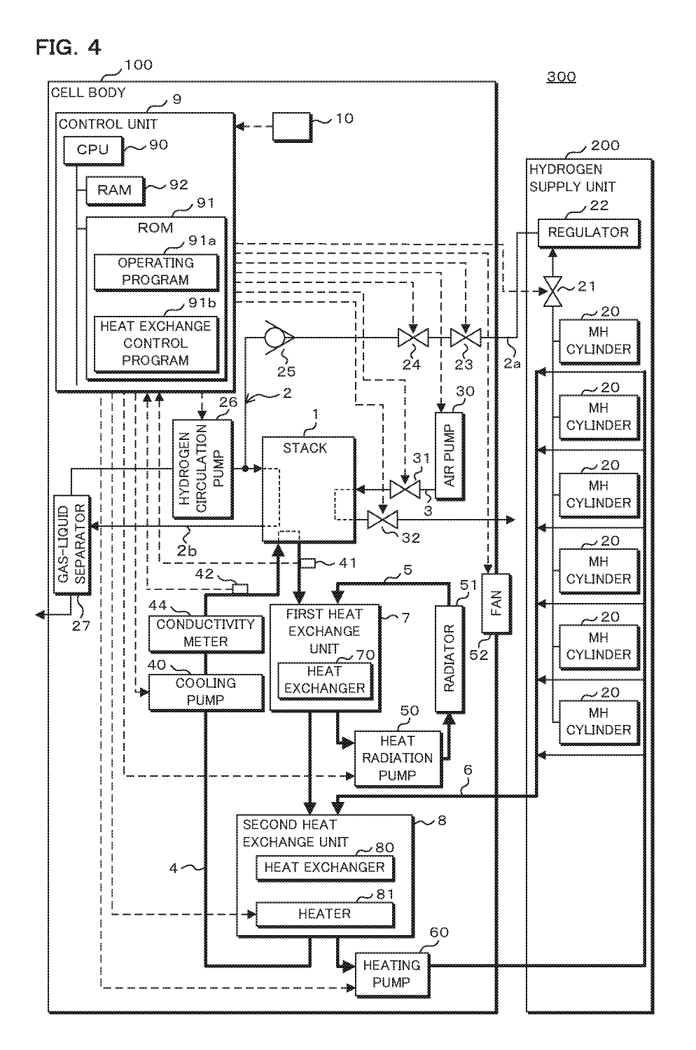

FIG. 4 is a block diagram illustrating a fuel cell according to Embodiment 2. A fuel cell 301 according to Embodiment 2 has a structure similar to the fuel cell 300 according to Embodiment 1 except that a cell body 100 of the fuel cell 301 is not provided with an ion exchange resin 43.

In this embodiment, the cooling passage is divided into a stack cooling passage 4 and a radiator flow passage 5, and impurities such as metal ions generated at a radiator 51 do not flow through the stack cooling passage 4.

Accordingly, it is possible to omit ion exchange resin at the stack cooling passage 4.

This achieves cost down of the fuel cell 301 itself.

As mentioned above, a fuel cell according to an aspect of the present disclosure comprises: a power generation unit cooling passage configured to cool a power generation unit, which generates electricity by reacting hydrogen and oxygen, by circulation of a first heat medium; a radiator flow passage, which allows a second heat medium to flow through a radiator and circulate; a first circulation pump provided at the power generation unit cooling passage; a second circulation pump provided at the radiator flow passage; and a heat exchanger configured to perform heat exchange between the first heat medium and the second heat medium; a first temperature detector configured to detect temperature of the first heat medium on an inlet side of the power generation unit; and a second temperature detector configured to detect temperature of the first heat medium on an outlet side of the power generation unit, wherein the fuel cell is constructed in a manner such that output of the first circulation pump or the second circulation pump is controlled on the basis of temperature detected by the first temperature detector or the second temperature detector and output of the second circulation pump is decreased if the temperature of the first heat medium detected by the second temperature detector is equal to or lower than a predetermined value.

In the aspect, the cooling passage is divided between the power generation unit side and the radiator side, and each of the power generation unit cooling passage and the radiator flow passage has a simple structure and a small length. Accordingly, the area of a pollution source such as piping becomes smaller, the level of contamination of the first heat medium and the second heat medium becomes lower, lowering of the power generation efficiency of the power generation unit due to rise in the conductivity caused by metal ions or the like is suppressed, and shortening of the life of the power generation unit is suppressed.

In addition, since the cooling passage is divided into two paths, it is possible to use pure water in a case where antifreeze liquid cannot be used as the first heat medium on the power generation unit side, and use antifreeze liquid as the second heat medium on the radiator side. In such a case, it is unnecessary to use SUS or the like wherein the elution amount of metal ions is small as the material of the path parts such as the radiator of the radiator flow passage, and aluminum can be used.

Moreover, in this aspect, it is possible to control the heat radiation amount by only controlling the flow rate of the radiator flow passage without depending on the flow rate of the power generation unit cooling passage side. Accordingly, it is possible to control the flow rate of the radiator flow passage so as to control the heat radiation amount while securing a minimum required ventilation volume of (a housing of) the fuel cell. It is therefore possible to use a common fan as a fan for a housing and a radiator fan.

In the aspect, it is possible to control the heat quantity, which is transferred in a heat exchanger, by controlling outputs of the two circulation pumps, that is, the circulation volume on the basis of the temperature. Since the heat quantity taken at a heat exchanger increases as the circulation volume of the radiator flow passage becomes larger, it is possible to finely control the heat quantity by suitably combining outputs of the two pumps.

A fuel cell of Japanese Patent Application Laid-Open No. 2003-168461 is constructed in a manner such that cooling water bypasses a passage to the radiator when the temperature of the cooling water is lower than a predetermined value, and a time lag is generated by a three-way selector valve between a closed loop and a radiator passage in such a case. On the contrary, no time lag is generated in the case of the aspect.

In addition, since it is possible to manage the temperature difference of cooling water between the input side and the output side of the power generation unit, it is possible to stabilize the temperature of the power generation unit even under low-temperature environment.

In the aspect, the heat quantity taken at a heat exchanger is restricted and overcooling of the cooling water is prevented by decreasing the output of the second circulation pump if the temperature of the first heat medium detected by the second temperature detector is equal to or lower than a predetermined value.

In the fuel cell, the second heat medium is antifreeze liquid.

Since the second heat medium in the aspect is antifreeze liquid including various chemical agents such as a rust-preventive agent, the parts of the radiator flow passage hardly rust. Moreover, a hole is hardly formed in a case where a radiator made of aluminum is employed. In addition, freezing does not occur in the radiator flow passage even when the outside air temperature is below the freezing point.

The fuel cell according to another aspect of the present disclosure further comprises a fan configured to cool the radiator, perform ventilation, and dilute and discharge hydrogen if hydrogen leaks.

In the aspect, it is possible to provide one fan with three functions, and cost down is achieved.

In the fuel cell, the fan rotates when the power generation unit is generating electricity.

In the aspect, it is possible to immediately dilute and discharge hydrogen when hydrogen leaks.

The fuel cell according to another aspect of the present disclosure further comprises a hydrogen sensor configured to detect leakage of hydrogen, wherein the fan continues rotating and the first circulation pump and the second circulation pump stop if the hydrogen sensor detects leakage of hydrogen.

In the aspect, it is possible to stop the entire system of the fuel cell so as to stop supply of hydrogen and to dilute hydrogen, which has leaked, and discharge the hydrogen to outside when hydrogen leaks.

In the fuel cell, the power generation unit cooling passage, the heat exchanger and the radiator flow passage are covered with heat insulating material.

In the aspect, since it is possible to restrict heat transfer with outside, it is easy to control the heat quantity.

A control method according to an aspect of the present disclosure of controlling heat exchange in a fuel cell, which is provided with a power generation unit cooling passage that allows a first circulation pump to circulate a first heat medium so as to cool a power generation unit configured to generate electricity by reacting hydrogen and oxygen, a radiator flow passage that allows a second circulation pump to circulate a second heat medium configured to conduct heat generated by the power generation unit to a radiator, and a heat exchanger configured to perform heat exchange between the first heat medium and the second heat medium, comprises: acquiring temperature of the first heat medium on an inlet side of the power generation unit or temperature of the first heat medium on an outlet side of the power generation unit; controlling output of the first circulation pump or the second circulation pump on the basis of temperature of the first heat medium on the inlet side or the outlet side; and decreasing output of the second circulation pump if the temperature of the first heat medium on the outlet side is equal to or lower than a predetermined value, in controlling the output of the second circulation pump.

In the aspect, it is possible to control the heat quantity, which is transferred in a heat exchanger, by controlling outputs of the two circulation pumps, that is, the circulation volume on the basis of the temperature. Since the heat quantity taken at a heat exchanger increases as the circulation volume of the radiator flow passage becomes larger, it is possible to finely control the heat quantity by suitably combining outputs of the two pumps. A time lag, which is generated by switching between a closed loop and a radiator passage in a fuel cell of Japanese Patent Application Laid-Open No. 2003-168461, is not generated.

In addition, since it is possible to manage the temperature difference of cooling water between the input side and the output side of the power generation unit, it is possible to stabilize the temperature of the power generation unit even under low-temperature environment.

In the aspect, it is possible to control the heat quantity, which is transferred in a heat exchanger, by controlling outputs of the two circulation pumps, that is, the circulation volume on the basis of the temperature. Since the heat quantity taken at a heat exchanger increases as the circulation volume of the radiator flow passage becomes larger, it is possible to finely control the heat quantity by suitably combining outputs of the two pumps.

In the aspect, the heat quantity taken at a heat exchanger is restricted and overcooling of the cooling water is prevented by decreasing the output of the second circulation pump if the temperature of the first heat medium on the outlet side is equal to or lower than a predetermined value.

In a non-transitory computer readable recording medium according to an aspect of the present disclosure, storing a computer program for causing a computer to control heat exchange in the fuel cell provided with a power generation unit cooling passage that allows a first circulation pump to circulate a first heat medium so as to cool a power generation unit configured to generate electricity by reacting hydrogen and oxygen, a radiator flow passage that allows a second circulation pump to circulate a second heat medium configured to conduct heat generated by the power generation unit to a radiator, and a heat exchanger configured to perform heat exchange between the first heat medium and the second heat medium, the computer program causes the computer to execute processing of: acquiring temperature of the first heat medium on an inlet side of the power generation unit or temperature of the first heat medium on an outlet side of the power generation unit; controlling output of the first circulation pump or the second circulation pump on the basis of temperature of the first heat medium on the inlet side or the outlet side; and decreasing output of the second circulation pump if the temperature of the first heat medium on the outlet side is equal to or lower than a predetermined value, in controlling the output of the second circulation pump.

In the aspect, it is possible to control the heat quantity, which is transferred in a heat exchanger, by controlling outputs of the two circulation pumps, that is, the circulation volume on the basis of the temperature. Since the heat quantity taken at a heat exchanger increases as the circulation volume of a radiator flow passage becomes larger, it is possible to finely control the heat quantity by suitably combining outputs of the two pumps. A time lag, which is generated by switching between a closed loop and a radiator passage in a fuel cell of Japanese Patent Application Laid-Open No. 2003-168461, is not generated.

In addition, since it is possible to manage the temperature difference of cooling water between the input side and the output side of the power generation unit, it is possible to stabilize the temperature of the power generation unit even under low-temperature environment.

In the aspect, it is possible to control the heat quantity, which is transferred in a heat exchanger, by controlling outputs of the two circulation pumps, that is, the circulation volume on the basis of the temperature. Since the heat quantity taken at a heat exchanger increases as the circulation volume of the radiator flow passage becomes larger, it is possible to finely control the heat quantity by suitably combining outputs of the two pumps.

In the aspect, the heat quantity taken at a heat exchanger is restricted and overcooling of the cooling water is prevented by decreasing the output of the second circulation pump if the temperature of the first heat medium on the outlet side is equal to or lower than a predetermined value.

It is to be noted that, as used herein and in the appended claims, the singular forms “a”, “an”, and “the” include plural referents unless the context clearly dictates otherwise.

The present invention is not limited to the contents of Embodiments 1 and 2 described above, and various modifications can be made within the scope indicated by the appended claims. That is, embodiments to be obtained by combining technical measures obtained from suitable modifications within the scope indicated by the claims are also included in the technical scope of the present invention.

What is claimed is:

1. A fuel cell comprising:
a power generation unit cooling passage configured to cool a power generation unit, which generates electricity by reacting hydrogen and oxygen, by circulation of a first heat medium;
a radiator flow passage, which allows a second heat medium to flow through a radiator and circulate;
a first circulation pump provided at the power generation unit cooling passage;
a second circulation pump provided at the radiator flow passage;
a heat exchanger configured to perform heat exchange between the first heat medium and the second heat medium;
a first temperature detector configured to detect temperature of the first heat medium on an inlet side of the power generation unit; and
a second temperature detector configured to detect temperature of the first heat medium on an outlet side of the power generation unit, wherein
the fuel cell is constructed in a manner such that output of the first circulation pump or the second circulation pump is controlled on the basis of temperature detected by the first temperature detector or the second temperature detector and output of the second circulation pump is decreased if the temperature of the first heat medium detected by the second temperature detector is equal to or lower than a predetermined value.

2. The fuel cell according to claim 1, further comprising a fan configured to cool the radiator, perform ventilation, and dilute and discharge hydrogen if hydrogen leaks.

3. The fuel cell according to claim 2, wherein the fan rotates when the power generation unit is generating electricity.

4. The fuel cell according to claim 1, wherein the power generation unit cooling passage, the heat exchanger and the radiator flow passage are covered with heat insulating material.

5. The fuel cell according to claim 2, wherein the power generation unit cooling passage, the heat exchanger and the radiator flow passage are covered with heat insulating material.

6. The fuel cell according to claim 3, wherein the power generation unit cooling passage, the heat exchanger and the radiator flow passage are covered with heat insulating material.

7. A control method of controlling heat exchange in a fuel cell, which is provided with a power generation unit cooling passage that allows a first circulation pump to circulate a first heat medium so as to cool a power generation unit configured to generate electricity by reacting hydrogen and oxygen, a radiator flow passage that allows a second circulation pump to circulate a second heat medium configured to conduct heat generated by the power generation unit to a radiator, and a heat exchanger configured to perform heat exchange between the first heat medium and the second heat medium, wherein the control method comprises:
acquiring temperature of the first heat medium on an inlet side of the power generation unit or temperature of the first heat medium on an outlet side of the power generation unit;
controlling output of the first circulation pump or the second circulation pump on the basis of temperature of the first heat medium on the inlet side or the outlet side; and
decreasing output of the second circulation pump if the temperature of the first heat medium on the outlet side is equal to or lower than a predetermined value, in controlling the output of the second circulation pump.

8. A non-transitory computer readable recording medium storing a computer program for causing a computer to control heat exchange in the fuel cell provided with a power generation unit cooling passage that allows a first circulation pump to circulate a first heat medium so as to cool a power generation unit configured to generate electricity by reacting hydrogen and oxygen, a radiator flow passage that allows a second circulation pump to circulate a second heat medium configured to conduct heat generated by the power generation unit to a radiator, and a heat exchanger configured to perform heat exchange between the first heat medium and the second heat medium, wherein
the computer program causes the computer to execute processing of:
acquiring temperature of the first heat medium on an inlet side of the power generation unit or temperature of the first heat medium on an outlet side of the power generation unit;
controlling output of the first circulation pump or the second circulation pump on the basis of temperature of the first heat medium on the inlet side or the outlet side; and
decreasing output of the second circulation pump if the temperature of the first heat medium on the outlet side is equal to or lower than a predetermined value, in controlling the output of the second circulation pump.
